(19) United States
(12) Patent Application Publication
(10) Pub. No.: US 2014/0011867 A1
(43) Pub. Date: Jan. 9, 2014

(54) EFFECT OF BORRELIDIN FOR CONTROLLING SOYBEAN PHYTOPHTHORA ROOT ROT

(71) Applicants: Wensheng Xiang, Zhejiang (CN); Jidong Wang, Zhejiang (CN); Xiangjing Wang, Zhejiang (CN); Chongxi Liu, Zhejiang (CN); Dianliang Gong, Zhejiang (CN); Hua Bai, Zhejiang (CN)

(72) Inventors: Wensheng Xiang, Zhejiang (CN); Jidong Wang, Zhejiang (CN); Xiangjing Wang, Zhejiang (CN); Chongxi Liu, Zhejiang (CN); Dianliang Gong, Zhejiang (CN); Hua Bai, Zhejiang (CN)

(73) Assignee: ZHEJIANG HISUN PHARMACEUTICAL CO., LTD., Zhejiang, ` (CN)

(21) Appl. No.: 14/005,951

(22) PCT Filed: Mar. 25, 2011
(86) PCT No.: PCT/CN11/72160

§ 371 Date: Sep. 18, 2013

(51) Int. Cl. A01N 43/22

(52) U.S. Cl. CPC A01N 43/22
USPC 514/450

(57) ABSTRACT

The present invention discloses use of borrelidin for preventing and controlling phytophthora root rot of soybean. The present invention also discloses formulations of borrelidin seed coating agents and wettable powders and preparation methods thereof. Borrelidin exhibits significant effects on Phytophthora sojae. As compared with the conventional fungicide metalaxyl which is used for preventing and controlling phytophthora root rot of soybean, the mycelial growth inhibition assay indicates that the IC₅₀ and IC₉₅ values of borrelidin are 1/62 and 1/263, respectively, of those of metalaxyl. In the indoor pot-culture experiment, the seed coating agent and wettable powder exhibit significant controlling effects on phytophthora root rot of soybean.

### FIELD

The present invention relates generally to the field of pesticide technology and, more particularly, to a germicide compound for preventing and controlling phytophthora root rot of soybean-borrelidin, formulations of its seed coating agents and wettable powders, and methods for preparation thereof.

### BACKGROUND

Phytophthora root rot of soybean is a devastating soybean disease caused by Phytophthora sajae Kaufmann & Gerdemann. The disease was first discovered in the northeastern part of the State of Indiana in 1948 and in the northwestern part of the State of Ohio in 1951. In 1955, occurrences of the disease in the United States were first reported by Suhovecky et al, and the disease was thought to be caused by Phytophthora pathogens. In 1958, Kaufmann and Gerdemann found out after research of the pathogen that the pathogen is a new Phytophthora species and named it Phytophthora sojae. The bacterium has a specialized pathogenicity to soybean. The disease is characterized by its wide distribution and is primarily spread through soil and seeds. In the recent years, along with the ceaseless increase in soybean growing area and the increasingly intensification of continuous cropping, the harm of soybean root rot has worsened year after year and resulted in significantly decreased production. In the recent years, soybean production has generally experienced a yearly reduction of 10% to 30%. In seriously affected areas, the disease may cause a production reduction of 60% and even crop failure. It is therefore imperative to prevent and control the disease.

As there are limited applicable drugs for controlling phytophthora root rot of soybean in production, chemical prevention and control are still the primary measures taken for controlling the disease. Metalaxyl is currently one of the most effective drugs for the prevention and control of diseases caused by various phytophthora bacteria. However, as metalaxyl is a systemic fungicide with singular site of action, it is extremely easy for pathogenic bacteria to develop resistance to the drug. Numerous researchers have discovered that phytophthora is prone to develop resistance to metalaxyl, and this is directly indicated by decline in efficacy or drug failure causing huge production losses.

Borrelidin is a macrolide with a nitrile functional group, and its structural formula (I) is as shown below.

Borrelidin was first discovered as a result of its antibacterial activity (Berger et al, 1949), and it was later discovered to exhibit antiviral activity (Dichinson at al, 1965), pest and weed control activities (DE 3607287), angiogenesis inhibition activity (Wakabayashi et al, 1997), antifungal activity (DE19835669; U.S. Pat. No. 6,193,964), antimalarial activity (Otoguro et al, 2003) and other activities.

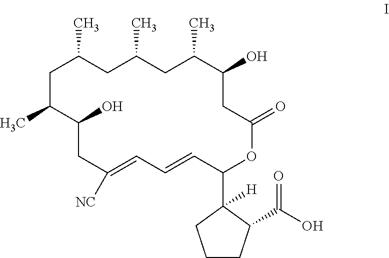 [SMILES: C[C@@H]1C[C@H](C)C[C@H](C)[C@@H](O)CC(=O)OC([C@@H]2CCC[C@H]2C(=O)O)/C=C/C=C(\C#N)C[C@H](O)[C@@H](C)C1]

Patents DE19835669 and U.S. Pat. No. 6,193,964 disclose the inhibition effects of borrelidin on a number of fungi, including Alternaria tenius; Botrytis cinerea; Colletotrichum musae; Fusarium oxysporum f. sp. (niveum); Phoma asparagi; Phytophthora capsici; Phytophthora cinnamomi; Pythium aphanidermatum; Pythium splendens; Pythium spinosum; Pythium ultimum; Rhizoctonia solani; Sclerotinia sclerotiorum; Sclerotium rolfsii; especially on Pythium species and Phytophthora species. It is also disclosed in the aforementioned patents that the IC₅₀ values of borrelidin against Pythium aphanidermatum, Pythium splendens, Pythium ultimum, Phytophthora capsici are 0.06, 0.03, 0.01, 0.10 and 0.027 respectively. The patents also disclose that borrelidin may be applied to tomato, aubergine, green chilli, cucumber, watermelon, pumpkin, cabbage, pea and other crops, but they have not disclosed the inhibition effects of borrelidin on Phytophthora sajae Kaufmann & Gerdemann.

### SUMMARY OF THE INVENTION

The present invention aims at providing an application of borrelidin for preventing and controlling phytophthora root rot of soybean, which effectively inhibits mycelial growth.

The present invention overcomes the foregoing problems through the following technical scheme: application of borrelidin for preventing and controlling phytophthora root rot of soybean.

Preferably, the borrelidin is a coating agent or wettable powder.

Preferably, the seed coating agent comprises the following components in weight percent terms:

borrelidin: 0.5%˜5%;

film-forming agent: 1%˜2%;

thickening agent: 0.5%˜2%;

dispersing agent: 1%˜3%;

viscosity stabilizing agent: 1%˜3%;

defoaming agent: 0.1%˜0.2%;

warning coloration: a little; and

the remaining portion is water.

Preferably, the file forming agent is polyvinyl alcohol (PVA).

Preferably, the dispersing agent is calcium lignosulphonate.

Preferably, the viscosity stabilizing agent is n-butyl alcohol.

Preferably, the thickening agent is bentonite.

Preferably, the defoaming agent is tributyl phosphate (TBP).

Preferably, the warning coloration is acid brilliant scarlet.

Preferably, the method for preparation of the seed coating agent comprises the following steps:

(1) Mix borrelidin and the warning coloration with some of the water, and add the mixture into a homogenizing machine to undergo grinding and dispersing for 25˜35 minutes;

(2) Mix the film-forming agent with the remaining amount of water, and add the mixture into a homogenizing machine to undergo grinding and dispersing for 3˜5 minutes;

(3) Stir the dispersed product obtained from step (2), and add in at the same time the dispersing agent, the viscosity stabilizing agent and the thickening agent; mix thoroughly with the dispersed product obtained from step (1), add in the de-foaming agent, and obtain borrelidin seed coating agent after the completion of defoaming.

Preferably, the wettable powder comprises the following components in weight percent terms:

borrelidin: 0. 2%˜5%;

wetting agent: 2%˜6%;

dispersing agent: 5%˜10%; and

filler: 70%˜90%.

Preferably, the wetting agent is sodium dodecyl benzene sulfonate (SDBS).

Preferably, the dispersing agent is calcium lignosulphonate.

Preferably, the filler is inert bentonite.

Preferably, the method for preparation of the borrelidin wettable powder comprises the following steps: get the various components according to the prescribed weight proportions, mix them evenly; pulverize the mixture and pass through a 40˜45 μm pore size sieve, heat-dry to obtain borrelidin wettable powder.

The present invention innovatively discloses borrelidin's characteristic of resistance to Phytophthora sajae Kaufmann & Gerdemann, and that the IC₅₀ and IC₉₅ values of borrelidin indicated in the mycelial growth inhibition assay are 0.0056 and 0.026 respectively, which are 1/62 and 1/263, respectively, of those of the conventional fungicide metalaxyl which is used for preventing and controlling phytophthora root rot of soybean.

The present invention also innovatively discloses formulations of borrelidin seed coating agents and wettable powders, and methods for preparation thereof.

### DETAILED DESCRIPTION

The present invention is further illustrated in connection with its preferred embodiments as follows. It must however be noted that the scope of the present invention shall not be limited by these embodiments.

It must be noted that the various raw materials used in the following embodiments are in weight percent terms.

### Embodiment 1

### 0.5% Borrelidin Seed Coating Agent

Borrelidin: 0.5%; polyvinyl alcohol (PVA): 2%; calcium lignosulphonate: 3%; bentonite: 1%; n-butyl alcohol: 2%; tributyl phosphate (TBP): 0.15%; acid brilliant scarlet: a little; and the remaining portion is water.

Processes of preparation of the seed coating agent are as follows:
1. Mix borrelidin and the acid brilliant scarlet with some of the water, and add the mixture into a high speed homogenizing machine to undergo grinding and dispersing for 30 minutes to produce a standby liquid;
2. Mix the polyvinyl alcohol (PVA) with the remaining amount of water, cause the mixture to undergo high speed homogenizing for 3 minutes, introduce the mixture into a stirred tank for stirring, and add in at the same time the calcium lignosulphonate, the bentonite and the n-butyl alcohol; and mix thoroughly with the standby liquid obtained from step (1) for 2 hours;
3. Finally, add the tributyl phosphate (TBP) into the liquid mixture obtained from step (2), obtain product after the completion of defoaming, and perform analysis to obtain passable seed coating agent of the present invention.

### Embodiment 2

### 1% Borrelidin Seed Coating Agent

Borrelidin: 1%; polyvinyl alcohol (PVA): 2%; calcium lignosulphonate: 3%; bentonite: 2%; n-butyl alcohol: 2%; tributyl phosphate (TBP): 0.15%; acid brilliant scarlet: a little; and the remaining portion is water.

Processes of preparation of the seed coating agent are as follows:
1. Mix borrelidin and the acid brilliant scarlet with some of the water, and add the mixture into a high speed homogenizing machine to undergo grinding and dispersing for 30 minutes to produce a standby liquid;
2. Mix the polyvinyl alcohol (PVA) with the remaining amount of water, cause the mixture to undergo high speed homogenizing for 5 minutes, introduce the mixture into a stirred tank for stirring, and add in at the same time the calcium lignosulphonate, the bentonite and the n-butyl alcohol; and mix thoroughly with the standby liquid obtained from step (1) for 1 hour;
3. Finally, add the tributyl phosphate (TBP) into the liquid mixture obtained from step (2), obtain product after the completion of defoaming, and perform analysis to obtain passable seed coating agent of the present invention.

### Embodiment 3

### 1.5% Borrelidin Seed Coating Agent

Borrelidin: 1.5%; polyvinyl alcohol (PVA): 1%; calcium lignosulphonate: 2%; bentonite: 2%; n-butyl alcohol: 1%; tributyl phosphate (TBP): 0.15%; acid brilliant scarlet: a little; and the remaining portion is water.

Processes of preparation of the seed coating agent are as follows:
1. Mix borrelidin and the acid brilliant scarlet with some of the water, and add the mixture into a high speed homogenizing machine to undergo grinding and dispersing for 30 minutes to produce a standby liquid;
2. Mix the polyvinyl alcohol (PVA) with the remaining amount of water, cause the mixture to undergo high speed homogenizing for 4 minutes, introduce the mixture into a stirred tank for stirring, and add in at the same time the calcium lignosulphonate, the bentonite and the n-butyl alcohol; and mix thoroughly with the standby liquid obtained from step (1) for 1.5 hours;
3. Finally, add the tributyl phosphate (TBP) into the liquid mixture obtained from step (2), obtain product after the completion of defoaming, and perform analysis to obtain passable seed coating agent of the present invention.

### Embodiment 4

### 2% Borrelidin Seed Coating Agent

Borrelidin: 2%; polyvinyl alcohol (PVA): 2%; calcium lignosulphonate: 2%; bentonite: 2%; n-butyl alcohol: 2%; tributyl phosphate (TBP): 0.15%; acid brilliant scarlet: a little; and the remaining portion is water.

Processes of preparation of the seed coating agent are as follows:
1. Mix borrelidin and the acid brilliant scarlet with some of the water, and add the mixture into a high speed homogenizing machine to undergo grinding and dispersing for 30 minutes to produce a standby liquid;
2. Mix the polyvinyl alcohol (PVA) with the remaining amount of water, cause the mixture to undergo high speed homogenizing for 5 minutes, introduce the mixture into a stirred tank for stirring, and add in at the same time the calcium lignosulphonate, the bentonite and the n-butyl alcohol; and mix thoroughly with the standby liquid obtained from step (1) for 1.2 hours;
3. Finally, add the tributyl phosphate (TBP) into the liquid mixture obtained from step (2), obtain product after the completion of defoaming, and perform analysis to obtain passable seed coating agent of the present invention.

### Embodiment 5

### 2% Borrelidin Wettable Powder

Borrelidin: 2%; sodium dodecyl benzene sulfonate (SDBS): 5%; calcium lignosulphonate: 5%; inert bentonite: 88%.

Processes of preparation of the wettable powder are as follows:
1. Compute the dosage of each component in weight percent terms, weigh and mix evenly;
2. Pulverize the ingredients using an airslide disintegrating mill, and pass through a 40-45pm pore size test sieve for grading;
3. Further mix evenly;
4. Heat-dry and perform analysis before storage.

### Embodiment 6

### 5% Borrelidin Wettable Powder

Borrelidin: 5%; sodium dodecyl benzene sulfonate (SDBS): 5%; calcium lignosulphonate: 5%; inert bentonite: 85%.

Processes of preparation of the wettable powder are as follows:
1. Compute the dosage of each component in weight percent terms, weigh and mix evenly;
2. Pulverize the ingredients using an airslide disintegrating mill, and pass through a 40-45 μm pore size test sieve for grading;
3. Further mix evenly;
4. Heat-dry and perform analysis before storage.

### Embodiment 7

### Mycelial Growth Inhibition Essay

Indoor assays of active compound borrelidin and active compound metalaxyl for their inhibitory effects against Phytophthora sajae Kaufmann & Gerdeman were carried out.

Growth rate method was used in the assays. The two active compounds were first formulated in a series of concentration gradients. Phytophthora sajae Kaufmann & Gerdeman cultures after 7 days of culture were punched using a sterile punch (Ø0.5cm) and put on standby, and the cultures were later transferred onto citrate-acetate (CA) plate culture media and placed at a temperature of 27±1° C., and colony diameters were measured after 7 days of culture. Each treatment process was repeated thrice; the measured results were compared with the inhibition rates of the control group, and their IC₅₀ and IC₉₅ values were computed.

TABLE 1
Inhibitory Effects of Bactericidal Agent on
Mycelial Growth of Phytophthora sajae

| Compound | IC₅₀ (μg/ml) | IC₉₅ (μg/ml) |
|---|---|---|
| Borrelidin | 0.0056 | 0.026 |
| Metalaxyl | 0.35 | 6.85 |

### Embodiment 8

### Borrelidin Seed Coating Agent Pot-culture Experiment

For indoor pot-culture experiment, 25 pots were divided into 5 groups of which 4 groups were seed coating agents with different effective contents, seed coating agents were used for soybean seed coating treatment (pesticide/seed mass ratio 1:50), and the other 1 group was the control group with each group having 5 pots. All groups of pots were inoculated with Phytophthora sajae Kaufmann & Gerdeman, and each pot was sown with 30 soybean seeds (soybean variety Hefeng No. 25). The disease prevention effects of the seed coating agents are as shown in Table 2. It can be seen from Table 2 that anti-disease soybean seed coating agents have very significant controlling effects on phytophthora root rot of soybean.

TABLE 2
Disease Prevention Effect of Borrelidin Seed Coating Agent

| | Disease |
|---|---|
| | Prevention |
| Drug Tested | Effect (%) |
| 0.5% Borrelidin Seed Coating Agent (Embodiment 1) | 95.4 |
| 1% Borrelidin Seed Coating Agent (Embodiment 2) | 96.2 |
| 1.5% Borrelidin Seed Coating Agent (Embodiment 3) | 97.4 |
| 2% Borrelidin Seed Coating Agent (Embodiment 4) | 97.2 |
| Control Group | — |

### Embodiment 9

### Borrelidin Wettable Powder Pot-Culture Experiment

All treatment processes were repeated thrice with 10 seedlings being treated each time, and the experiment was performed in a greenhouse with the pots arranged randomly. The drugs to be tested were prepared and delivered separately according to their respective required concentrations in a morning of a sunny day, and inoculation was performed after drug absorption. The hypocotyl inoculation method was used, and the seedlings were cultivated in a humid atmosphere after inoculation. The weather during the experiment was mostly sunny, and the lowest temperature in the greenhouse shed was 18° C., the highest temperature therein was 30° C., the average temperature therein was 24° C., and the relative humidity therein was above 80%. The disease prevention effects of borrelidin wettable powders are as shown in Table 3.

TABLE 3
Disease Prevention Effect of Borrelidin Wettable Powder

| | | Disease |
|---|---|---|
| | | Prevention |
| Drug Tested | Preparation Dosage | Effect (%) |
| 2% Borrelidin Wettable Powder | 1000 times | 93.9 |
| (Embodiment 5) | | |
| 5% Borrelidin Wettable Powder | 1000 times | 97.8 |
| (Embodiment 6) | | |

The foregoing text sets forth only preferred embodiments of the present invention, and it must be noted that various modifications, additions and alterations may be made to the invention by those of ordinary skill in the art without departing from the spirit of the invention, and such modifications, additions and alterations would fall within the scope of the invention.

1. A method of preventing and controlling phytophthora root rot of soybean comprising the step of providing borrelidin for application to soybean.

2. The method as in claim 1, wherein the borrelidin is a seed coating agent or wettable powder.

3. The method as in claim 2, wherein the seed coating agent comprises the following components in weight percent terms:
borrelidin: 0.5%˜5%;
film-forming agent: 1%˜2%;
thickening agent: 0.5%˜2%;
dispersing agent: 1%˜3%;
viscosity stabilizing agent: 1%˜3%;
defoaming agent: 0.1%˜0.2%;
warning coloration: a little; and
the remaining portion is water.

4. The method as in claim 3, wherein the film forming agent is polyvinyl alcohol (PVA).

5. The method as in claim 3, wherein the dispersing agent is calcium lignosulphonate.

6. The method as in claim 3, wherein the viscosity stabilizing agent is n-butyl alcohol.

7. The method as claim 3, wherein the thickening agent is bentonite.

8. The method as in claim 3, wherein the defoaming agent is tributyl phosphate (TBP).

9. The method as in claim 3, wherein the warning coloration is acid brilliant scarlet.

10. The method as defined in claim 3, wherein the seed coating agent is prepared by a method comprising the following steps:
(1) mixing borrelidin and a warning coloration with an amount of water, and adding the mixture into a homogenizing machine to undergo grinding and dispersing for 25˜35 minutes;
(2) mixing a film-forming agent with a remaining amount of water, and adding the mixture into a homogenizing machine to undergo grinding and dispersing for 3—5 minutes;
(3) stirring the dispersed product obtained from step (2), and adding in at the same time a dispersing agent, a viscosity stabilizing agent and a thickening agent; mixing with the dispersed product obtained from step (1), add in a de-foaming agent, wherein a borrelidin seed coating agent is obtained after the completion of defoaming.

11. The method as claim 2, wherein the wettable powder comprises the following components in weight percent terms:
borrelidin: 0.2%˜5%;
wetting agent: 2%˜6%;
dispersing agent: 5%˜10%; and
filler: 70%˜90%.

12. The method as in claim 11, wherein the wetting agent is sodium dodecyl benzene sulfonate (SDBS).

13. The method as defined in claim 11, wherein the dispersing agent is calcium lignosulphonate.

14. The method as claim 11, wherein the filler is inert bentonite.

15. The method as claim 11, wherein the method for preparing the borrelidin wettable powder comprises the steps of:
providing components in a weight percent as follows, borrelidin in an amount of 2%˜5% wt %; wetting agent in an amount of 2%˜6% wt %; dispersing agent in an amount of 5%˜10% wt %; and filler in an amount of 70%˜90% wt %,
mixing the components evenly;
pulverizing the mixture and passing through a 40˜45 μm pore size sieve, and
heat-drying the to obtain borrelidin wettable powder.
